(19) United States
(12) Patent Application Publication
(10) Pub. No.: US 2022/0155505 A1
(43) Pub. Date: May 19, 2022

(54) LIGHT FILTERING LENSES

(71) Applicant: RYAN POLEHONKA, EAGAN, MN (US)

(72) Inventor: RYAN POLEHONKA, EAGAN, MN (US)

(21) Appl. No.: 17/523,760

(22) Filed: Nov. 10, 2021

Related U.S. Application Data
(60) Provisional application No. 63/115,694, filed on Nov. 19, 2020.

(51) Int. Cl. G02B 5/22; G02B 1/11

(52) U.S. Cl. CPC G02B 5/22; G02B 1/11

(57) ABSTRACT

A light filtering lens has a curved, transparent, glass or polymer member designed to be disposed within a rim portion of a glasses frame member. An optically filtering dye coating with a rose tint is disposed on the curved, transparent, glass or polymer member and is designed to filter up to twenty percent of light substantially between 380 nanometers and 470 nanometers. The optically filtering dye coating with a rose tint is designed to filter up to thirty-five percent of light substantially between 380 nanometers and 500 nanometers. An optically filtering anti-glare and blue light coating is disposed on the curved, transparent, glass or polymer member designed to filter up to thirty-five percent of light substantially between 380 nanometers and 500 nanometers. The optically filtering dye coating with a rose tint may be disposed in a gradient so that more visible light is filtered on an upper portion of the lens than the lower portion of the lens.

### CLAIM OF PRIORITY

This application claims priority to and the benefit of U.S. Provisional application with Ser. No. 63/115,694, filed on Nov. 19, 2020, with the same title, the contents of which are hereby incorporated by reference in its entirety.

### FIELD OF THE INVENTION

The inventive concept relates generally to light filtering lenses for a user.

### BACKGROUND

Blue light is a range of the visible light spectrum, defined as having a wavelength between 380-525 nanometers. This includes wavelengths between violet and cyan in the spectrum. Narrow-spectrum blue light such as blue LED light or short-wavelength light is a type of high-energy visible light, defined as having a wavelength between 380 and 450 nanometers. Blue light is an essential component of white light. White can be made from either narrow-spectrum or broad-spectrum blue. For example, LED technology tends to combine narrow-spectrum blue and yellow, while other technologies include more cyan and red. Fluorescent coatings generate violet and cyan spikes, in addition to having a smaller narrow-spectrum blue component. Natural light has a much more even distribution of blue wavelengths than most artificial light.

Research suggests that a large majority of migraine sufferers are photophobic, meaning they have a strong aversion to light during a migraine. Any type of light can trigger migraines, but blue light can be a leading contributor. Blue light from unfiltered fluorescent lamps may be a serious contributor to migraine pain if optically unfiltered.

An optical filter is a device that selectively transmits light of different wavelengths, usually implemented as a glass plane or plastic device in the optical path, which are either dyed in the bulk or have interference coatings. The optical properties of filters are completely described by their frequency response, which specifies how the magnitude and phase of each frequency component of an incoming signal is modified by the filter. Filters mostly belong to one of two categories. The simplest, physically, is the absorptive filter. There are also interference or dichroic filters. Many optical filters are used for optical imaging and are manufactured to be transparent. Some used for light sources can be translucent. Optical filters selectively transmit light in a particular range of wavelengths, that is, colors, while absorbing the remainder. Such filters can usually pass long wavelengths only, short wavelengths only, or a band of wavelengths, blocking both longer and shorter wavelengths. The passband may be narrower or wider. The transition or cutoff between maximal and minimal transmission can be sharp or gradual.

Currently, there are a number of solutions for easing strain and migraine headaches from computer screens related to blue light. One of these solutions is to use filtered glasses tinted with compounds to absorb harmful light, but such filtered glasses may be inconvenient for users when their filtering properties are unsuitable for viewing offscreen items. Unsuitability may be due to distorted colorations or the amount of light filtered. Another solution is to reduce screen light so the screen is not too bright, but this solution may make screens less convenient to see. Another solution is to upgrade computer screens to use models that emanate less harmful light such as a liquid crystal display (LCD), but these screens may be expensive and it may be difficult for users to know whether they are viewing such a screen. Yet another solution may be to apply filters directly to a computer screen, but this solution may be inconvenient to install or carry. Therefore, there currently exists a need in the market for improved eyewear that filters blue light from computer screens.

### SUMMARY OF THE INVENTION

The inventive concept addresses photophobia and associated migraines generated from blue spectrum light substantially between 500 nanometers to 380 nanometers. The inventive concept is preventative and may simply make working on a computer more comfortable for people even without these conditions. Photophobia is a debilitating symptom seen in many ophthalmic and neurologic disorders. Despite its prevalence, it is poorly understood and difficult to treat. However, the inventive concept addresses clinical characteristics and disorders associated with photophobia and relief from fluorescent and LED lighting.

The wavelength of light may affect the photophobia percept. Shorter wavelengths (blue) light substantially between 380 nanometers and 500 nanometers can be uncomfortable for subjects with migraines or other tension-type headaches. In the visible spectrum, short-wave blue light with wavelength between 415 nanometers and 455 nanometers is related to eye damage. Investigations report that visually provoked beta brain activity is suppressed by red light and enhanced with blue light in migraine patients, showing that the two wavelengths have different effects on cortical activity. The reasons for this difference, and the noxious nature of blue to migraineurs, are unclear, but affecting the light received by the eye is proved effective. The inventive concept addresses the light the eye receives by a combination of red dye tint and a blue-light reducing anti-glare coating that allows a reduction of blue light reaching the eye without overly blocking light from other visible spectrum beyond twenty percent, where ninety-seven percent of visible light is transmitted between 470 nanometers and 700 nanometers.

A light filtering lens has a curved, transparent, glass or polymer member designed to be disposed within a rim portion of a glasses frame member. An optically filtering dye coating with a tint such as, but not limited to, PMC5207664 is disposed on the curved, transparent, glass or polymer member and is designed to filter up to twenty-five percent of light substantially between 380 nanometers and 700 nanometers. The optically filtering dye coating with a rose tint is designed to filter up to thirty-five percent of light substantially between 380 nanometers and 500 nanometers passing through the curved, transparent, glass or polymer member. The specific readings in one embodiment are ninety-nine percent of blue light at 385 nanometers, forty-nine percent at 405 nanometers, fifteen percent at 456 nanometers, and four percent at 500 nanometers. A darker tint can allow filtering fifty percent between 380-500 nanometers. An optically filtering anti-glare and blue light coating is disposed on the curved, transparent, glass or polymer member designed to filter up to thirty-five percent of light substantially between 380 nanometers and 500 nanometers passing through the curved, transparent, glass or polymer member.

A rose tint could be FL 41 or another red-based tint. FL-41 is a type of specialty eyewear tint designed for people with light sensitivity and often recommended for patients with migraine, post-concussion syndrome and dozens of other light-sensitive conditions. Other red-based tints may be used and may appear rose to the naked eye.

In one embodiment of the inventive concept, the red dye at a ten percent tint blocks thirty-six percent of light at 386 nanometers and twelve percent at 500 nanometers. The tint may block up to twenty percent of light between 380 nanometers and 470 nanometers. In this representative embodiment, the tint blocks three percent of light between 470 nanometers and 700 nanometers.

In one embodiment of the light filtering lens, the optically filtering dye coating with a rose tint disposed on the curved, transparent, glass or polymer member is designed to filter up to five percent of light substantially between 380 nanometers and 700 nanometers.

In one embodiment of the light filtering lens, the optically filtering dye coating with a rose tint disposed on the curved, transparent, glass or polymer member is designed to filter up to fifteen percent of light substantially between 380 nanometers and 500 nanometers.

In one embodiment of the light filtering lens, the optically filtering anti-glare and blue light coating disposed on the curved, transparent, glass or polymer member is designed to filter up to fifteen percent of blue light substantially between 380 nanometers and 500 nanometers.

In one embodiment of the light filtering lens, the optically filtering dye coating with a rose tint is disposed on the curved, transparent, glass or polymer member as a gradient wherein the optically filtering dye coating with a rose tint is designed to filter up to thirty percent of light substantially between 380 nanometers and 470 nanometers at an upper portion of the curved, transparent, glass or polymer member and the optically filtering dye coating with a rose tint is designed to filter a lesser percentage of light down to five percent substantially between 380 nanometers and 470 nanometers at a lower portion of the curved, transparent, glass or polymer member than the light between 380 nanometers and 700 nanometers filtered at the upper portion of the curved, transparent, glass or polymer member. The various embodiments described above and hereinbelow include wearable glasses or lenses, filtering sheets or coatings for computer screens, smartphones and tablets and any other display.

Among other things, it is an advantage for the light filtering lens to not suffer from problems or deficiencies associated with prior solutions. It is still further an advantage of the light filtering lens to be durable and reusable. Still further, the inventive concept may cover lenses of many shapes, sizes, and curvatures.

The inventive concept now will be described more fully hereinafter with reference to the accompanying drawings, which are intended to be read in conjunction with both this summary, the detailed description, and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

Among other things, it is an advantage for the light filtering lens to not suffer from problems or deficiencies associated with prior solutions.

It is still further an advantage of the light filtering lens to be durable and reusable.

Still further, the inventive concept may cover lenses of many shapes, sizes, and curvatures.

Lenses are tinted by the application of a dye upon dipping the lens into a container containing the dye, and an anti-glare coating is applied to the outside of the lenses.

Glasses, also known as eyeglasses or spectacles, are vision aids, consisting of glass or hard polymer and polycarbonate lenses mounted in a frame that holds them in front of a person's eyes, typically utilizing a bridge over the nose and hinged arms which rest over the ears. Polycarbonate is a polymer. In one example embodiment, wearable contact lens, hard or soft, are configured with similar tinting techniques to similar reduce the effects of blue light on the user.

In another related embodiment, thin film transistor technology is usable to form the gradations of tinting necessary in the lenses of an eyeglasses user, which would include a power source (such as a battery or solar cell) to manually or automatically effect the proper tinting or shading desired by the user. Reference is made to U.S. Pat. No. 9,470,950 to Paolini which is hereby incorporated by reference in its entirety. Such an embodiment, would be wirelessly responsive to a smartphone applet that would provide for configuring the tinting by the user as well.

The inventive concept now will be described more fully hereinafter with reference to the accompanying drawings, which are intended to be read in conjunction with both this summary, the detailed description, and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIG. 1 illustrates a light filtering lens disposed within a glasses frame.

FIGS. 2A and 2B illustrate a side view and a front view, respectively, of a curved, transparent, glass or polymer member, the optically filtering dye coating with a rose tint, and the blue-light reducing anti-glare coating.

FIG. 3 illustrates the visible light spectrum.

FIG. 4 illustrates the blue light spectrum.

FIG. 5 illustrates the lens dye process for the inventive concept herein.

FIGS. 6A and 6B illustrate a side view and a front view, respectively, of the gradient tint of the curved, transparent, glass or polymer member, the optically filtering dye coating with a rose tint, and the blue-light reducing anti-glare coating.

FIGS. 7A and 7B illustrate front views of a rectangular and an oval curved, transparent, glass or polymer members.

FIGS. 8A through 8C illustrate a method for making and using the inventive concept.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

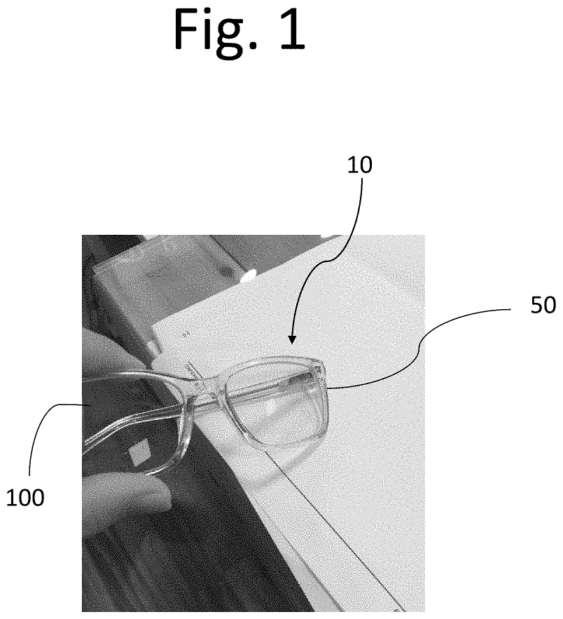

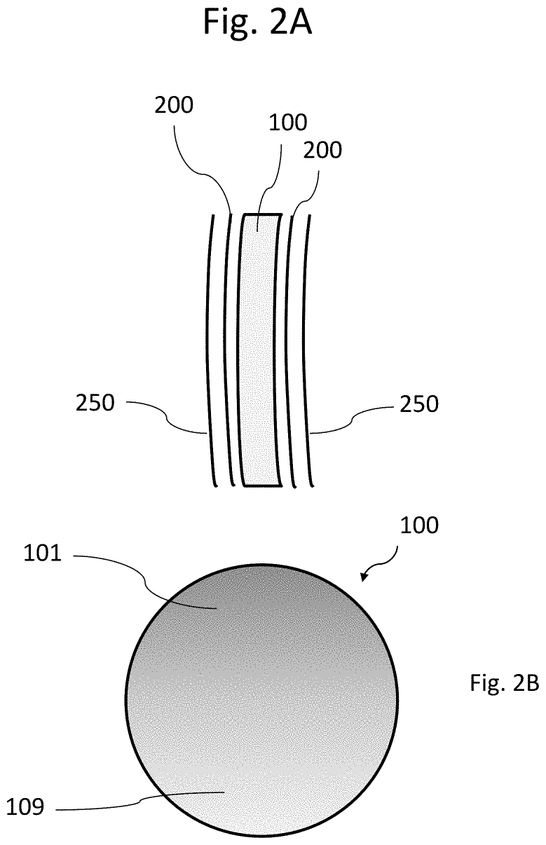

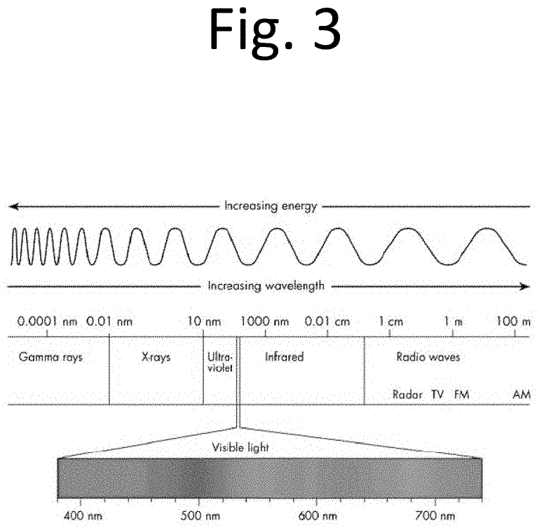

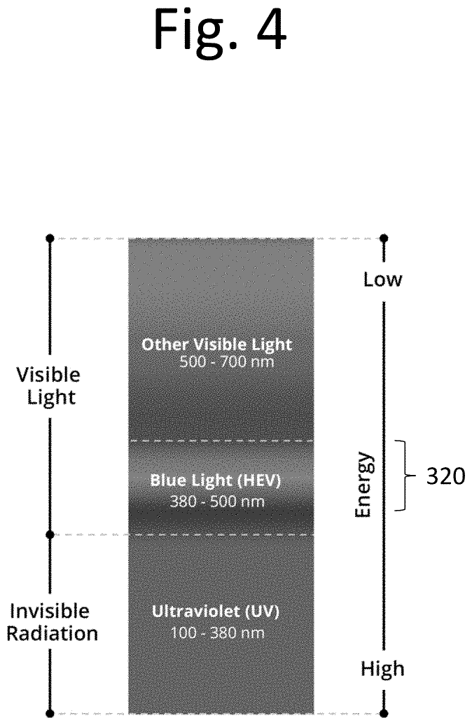

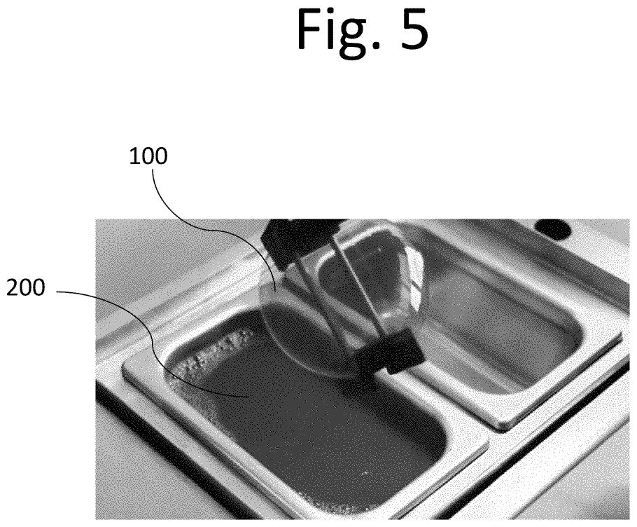

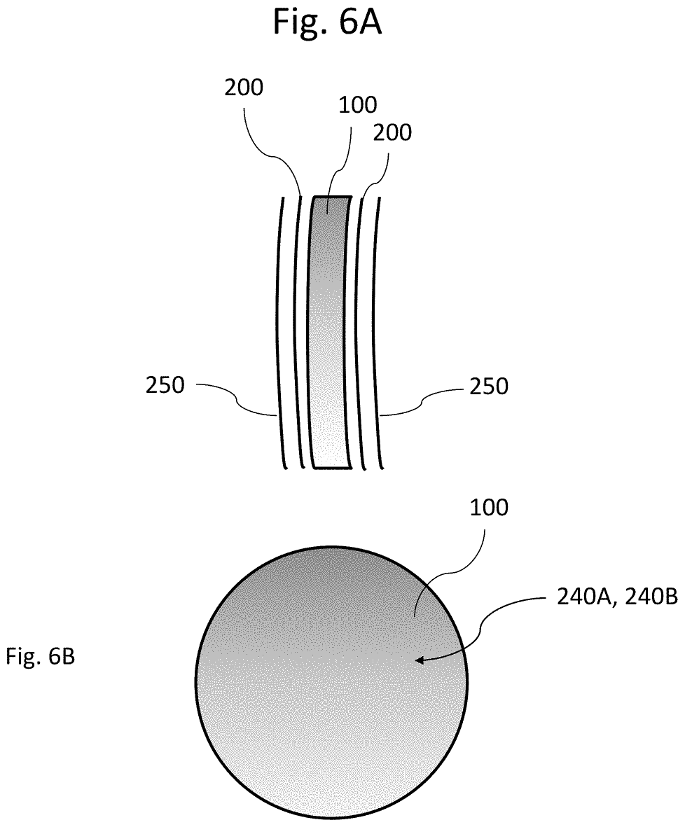

Referring to the Figures, FIGS. 1-6B illustrate a light filtering lens that has a curved, transparent, glass or polymer member 100 designed to be disposed within a rim portion 50 of a glasses frame member 10. An optically filtering dye coating with a rose tint 200 is disposed on the curved, transparent, glass or polymer member 100 and is designed to filter up to twenty-five percent of light substantially between 380 nanometers and 700 nanometers. Glass or polymer member 100 may be termed a lens and the inventive concept can be either or both glass and a polymer. The optically filtering dye coating with a rose tint is designed to filter up to thirty-five percent of light substantially between 380 nanometers and 500 nanometers. An optically filtering anti-glare and blue light coating 250 is disposed on the curved, transparent, glass or polymer member 100 designed to filter up to thirty-five percent of light substantially between 380 nanometers and 500 nanometers.

In one embodiment of the light filtering lens, the optically filtering dye coating with a rose tint 200 disposed on the curved, transparent, glass or polymer member 100 is designed to filter up to twenty percent of all light substantially between 380 nanometers and 470 nanometers and up to five percent of light between 470 nanometers and 700 nanometers.

In one embodiment of the light filtering lens, the optically filtering dye coating with a rose tint 200 disposed on the curved, transparent, glass or polymer member 100 is designed to filter up to fifteen percent of light substantially between 380 nanometers and 500 nanometers.

In one embodiment of the light filtering lens, the optically filtering anti-glare and blue light coating 250 disposed on the curved, transparent, glass or polymer member 100 is designed to filter up to fifteen percent of remaining light substantially between 380 nanometers and 500 nanometers.

In one embodiment of the light filtering lens, the optically filtering dye coating with a rose tint 200 is disposed on the curved, transparent, glass or polymer member 100 as a gradient 240A wherein the optically filtering dye coating with a rose tint 200 is designed to filter up to thirty percent of light substantially between 380 nanometers and 470 nanometers at an upper portion of the curved, transparent, glass or polymer member 101 and the optically filtering dye coating with a rose tint 200 is designed to filter a lesser percentage of light down to five percent substantially between 380 nanometers and 470 nanometers at a lower portion of the curved, transparent, glass or polymer member 109 than the light between 380 nanometers and 470 nanometers filtered at the upper portion of the curved, transparent, glass or polymer member 101.

In one embodiment of the light filtering lens, the optically filtering dye coating with a rose tint 200 is disposed on the curved, transparent, glass or polymer member 100, and when so disposed, affords a blue reflective appearance to the glass or polymer member.

In one embodiment of the light filtering lens, the optically filtering dye coating with a rose tint disposed on the curved, transparent, glass or polymer member 100 is adapted to filter up to fifty percent of light substantially between 380 nanometers and 500 nanometers.

In one embodiment of the light filtering lens, the optically filtering anti-glare and blue light coating 250 is disposed on the curved, transparent, glass or polymer member 100 as a gradient 240B wherein the optically filtering anti-glare and blue light coating 250 is adapted to filter up to thirty percent of light substantially between 380 nanometers and 470 nanometers at an upper portion of the curved, transparent, glass or polymer member 101 and the optically filtering anti-glare and blue light coating 250 is adapted to filter a lesser percentage of light down to five percent substantially between 380 nanometers and 470 nanometers at a lower portion of the curved, transparent, glass or polymer member 109 than the light between 380 nanometers and 470 nanometers filtered at the upper portion of the curved, transparent, glass or polymer member 101.

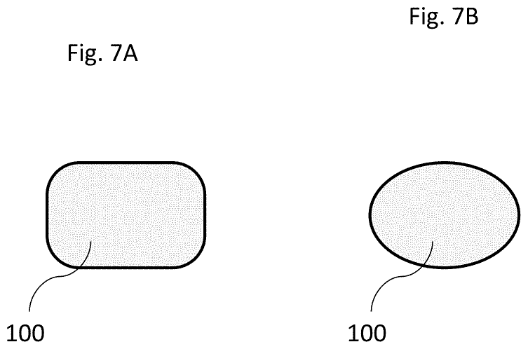

FIG. 7A illustrates that in one embodiment of the light filtering lens, the curved, transparent, glass or polymer member 100A is substantially rectangular and with a polymer frame member. In another embodiment FIG. 7B illustrates a curved, transparent, glass or polymer member 100B is substantially oval and with a polymer frame member. In another embodiment, the curved, transparent, glass or polymer member 100 forms a prescription lens.

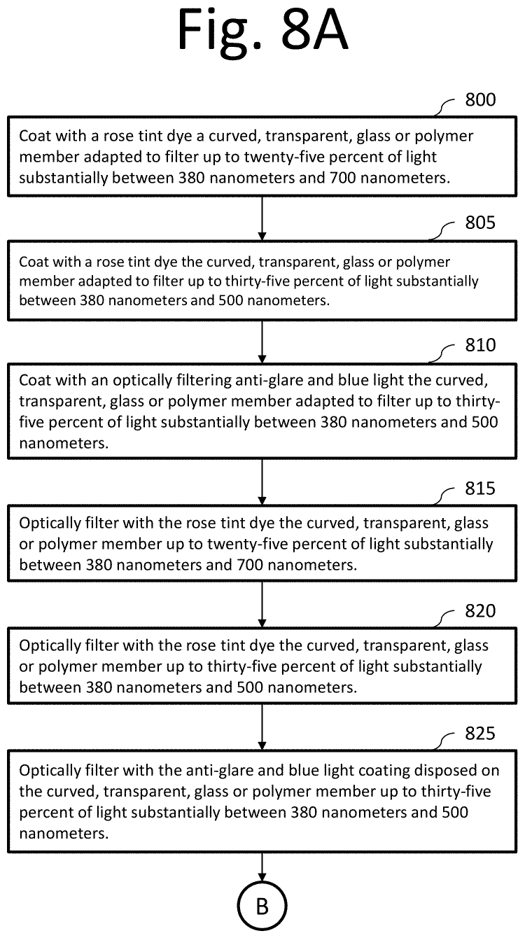

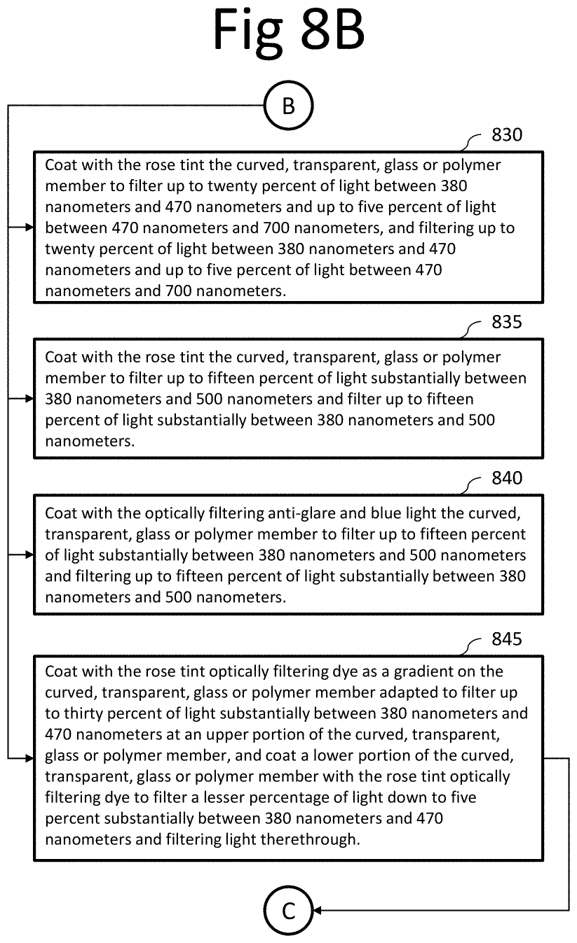

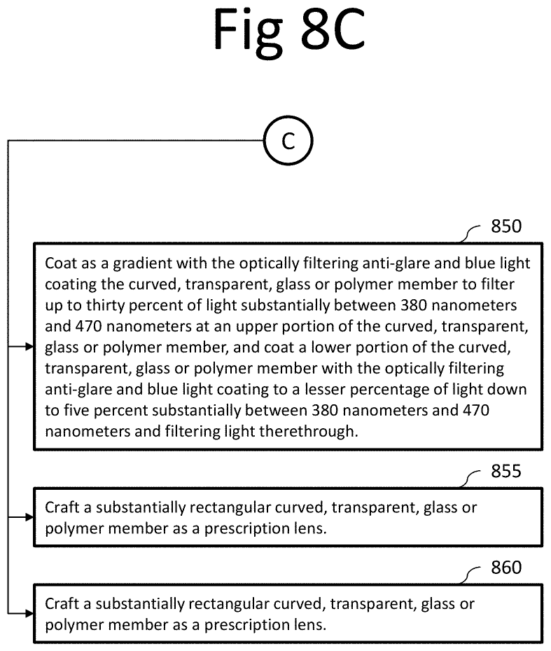

FIGS. 8A to 8C illustrate a method for filtering light to reduce photophobia, the method including the step 800 coating with a rose tint dye 200 a curved, transparent, glass or polymer member 100 adapted to filter up to twenty-five percent of light substantially between 380 nanometers and 700 nanometers. The method further includes the step 805 coating with a rose tint dye 200 the curved, transparent, glass or polymer member 100 adapted to filter up to thirty-five percent of light substantially between 380 nanometers and 500 nanometers. The method further includes the step 810 coating with an optically filtering anti-glare and blue light the curved, transparent, glass or polymer member 100 adapted to filter up to thirty-five percent of light substantially between 380 nanometers and 500 nanometers. The method further includes the step 815 optically filtering with the rose tint dye 200 the curved, transparent, glass or polymer member 100 up to twenty-five percent of light substantially between 380 nanometers and 700 nanometers. The method further includes the step 820 optically filtering with the rose tint dye 200 the curved, transparent, glass or polymer member 100 up to thirty-five percent of light substantially between 380 nanometers and 500 nanometers. The method further includes the step 825 optically filtering with the anti-glare and blue light coating disposed on the curved, transparent, glass or polymer member 100 up to thirty-five percent of light substantially between 380 nanometers and 500 nanometers.

FIGS. 8A to 8C may further include the step 830 coating with the rose tint 200 the curved, transparent, glass or polymer member 100 to filter up to twenty percent of light between 380 nanometers and 470 nanometers and up to five percent of light between 470 nanometers and 700 nanometers, and filtering up to twenty percent of light between 380 nanometers and 470 nanometers and up to five percent of light between 470 nanometers and 700 nanometers. The method further includes the step 835 coating with the rose tint 200 the curved, transparent, glass or polymer member 100 to filter up to fifteen percent of light substantially between 380 nanometers and 500 nanometers and filtering up to fifteen percent of light substantially between 380 nanometers and 500 nanometers. The method further includes the step 840 coating with the optically filtering anti-glare and blue light the curved, transparent, glass or polymer member 100 to filter up to fifteen percent of light substantially between 380 nanometers and 500 nanometers and filtering up to fifteen percent of light substantially between 380 nanometers and 500 nanometers.

FIGS. 8A to 8C illustrates that the method may further include the step 845 including coating with the rose tint 200 optically filtering dye as a gradient on the curved, transparent, glass or polymer member 100 adapted to filter up to thirty percent of light substantially between 380 nanometers and 470 nanometers at an upper portion of the curved, transparent, glass or polymer member 100, and coating a lower portion of the curved, transparent, glass or polymer member 100 with the rose tint 200 optically filtering dye to filter a lesser percentage of light down to five percent substantially between 380 nanometers and 470 nanometers and filtering light therethrough.

FIGS. 8A to 8C illustrates that the method may further include the step 850 coating as a gradient with the optically filtering anti-glare and blue light coating 250 the curved, transparent, glass or polymer member 100 to filter up to thirty percent of light substantially between 380 nanometers and 470 nanometers at an upper portion of the curved, transparent, glass or polymer member 100, and coating a lower portion of the curved, transparent, glass or polymer member 100 with the optically filtering anti-glare and blue light coating 250 to a lesser percentage of light down to five percent substantially between 380 nanometers and 470 nanometers and filtering light therethrough.

FIGS. 8A to 8C illustrates that the method may further include the step 855 crafting a substantially rectangular curved, transparent, glass or polymer member 100 as a prescription lens. The method may further include the step 860 crafting a substantially rectangular curved, transparent, glass or polymer member as a prescription lens.

The following patents and publications are incorporated by reference in their entireties: U.S. Pat. Nos. 9,470,950; 10,520,756; 10,606,101B2; 20150153591A1; and 20190310405A1, along with CA2655130A1. Cited also is J Neuroophthalmol. 2012 March; 32(1): 68-81, and Int J Ophthalmol. 2018; 11(12): 1999-2003. doi:10.1097/WNO.0b013e3182474548.

While the inventive concept has been described above in terms of specific embodiments, it is to be understood that the inventive concept is not limited to these disclosed embodiments. Upon reading the teachings of this disclosure many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. A light filtering lens comprising:
a curved, transparent, glass or polymer member adapted to be disposed within a rim portion of a glasses frame member;
an optically filtering dye coating with a rose tint disposed on the curved, transparent, glass or polymer member adapted to filter up to twenty-five percent of light substantially between 380 nanometers and 700 nanometers;
wherein the optically filtering dye coating with a rose tint disposed on the curved, transparent, glass or polymer member is adapted to filter up to thirty-five percent of light substantially between 380 nanometers and 500 nanometers; and
an optically filtering anti-glare and blue light coating disposed on the curved, transparent, glass or polymer member adapted to filter up to thirty-five percent of light substantially between 380 nanometers and 500 nanometers.

2. The light filtering lens of claim 1 wherein the optically filtering dye coating with a rose tint disposed on the curved, transparent, glass or polymer member is adapted to filter up to fifty percent of light substantially between 380 nanometers and 500 nanometers.

3. The light filtering lens of claim 1 wherein the optically filtering dye coating with a rose tint disposed on the curved, transparent, glass or polymer member is adapted to filter up to twenty percent of light between 380 nanometers and 470 nanometers and up to five percent of light between 470 nanometers and 700 nanometers.

4. The light filtering lens of claim 1 wherein the optically filtering dye coating with a rose tint disposed on the curved, transparent, glass or polymer member is adapted to filter up to fifteen percent of light substantially between 380 nanometers and 500 nanometers.

5. The light filtering lens of claim 1 wherein the optically filtering anti-glare and blue light coating disposed on the curved, transparent, glass or polymer member is adapted to filter up to fifteen percent of light substantially between 380 nanometers and 500 nanometers.

6. The light filtering lens of claim 4 wherein the optically filtering anti-glare and blue light coating disposed on the curved, transparent, glass or polymer member is adapted to filter up to fifteen percent of light substantially between 380 nanometers and 500 nanometers, and when so disposed, affords a blue reflective appearance to the glass or polymer member.

7. The light filtering lens of claim 1 wherein the optically filtering dye coating with a rose tint is disposed on the curved, transparent, glass or polymer member as a gradient wherein the optically filtering dye coating with a rose tint is adapted to filter up to thirty percent of light substantially between 380 nanometers and 470 nanometers at an upper portion of the curved, transparent, glass or polymer member and the optically filtering dye coating with a rose tint is adapted to filter a lesser percentage of light down to five percent substantially between 380 nanometers and 470 nanometers at a lower portion of the curved, transparent, glass or polymer member than the light between 380 nanometers and 470 nanometers filtered at the upper portion of the curved, transparent, glass or polymer member.

8. The light filtering lens of claim 1 wherein the optically filtering anti-glare and blue light coating is disposed on the curved, transparent, glass or polymer member as a gradient wherein the optically filtering anti-glare and blue light coating is adapted to filter up to thirty percent of light substantially between 380 nanometers and 470 nanometers at an upper portion of the curved, transparent, glass or polymer member and the optically filtering anti-glare and blue light coating is adapted to filter a lesser percentage of light down to five percent substantially between 380 nanometers and 470 nanometers at a lower portion of the curved, transparent, glass or polymer member than the light between 380 nanometers and 470 nanometers filtered at the upper portion of the curved, transparent, glass or polymer member.

9. The light filtering lens of claim 1 wherein the lens member is substantially rectangular and with a polymer frame member.

10. The light filtering lens of claim 1 wherein the lens member is substantially oval and with a polymer frame member.

11. The light filtering lens of claim 9 wherein the curved, transparent, glass or polymer member forms a prescription lens.

12. The light filtering lens of claim 10 wherein the curved, transparent, glass or polymer member forms a prescription lens

13. A method for filtering light to reduce photophobia, the method comprising:
coating with a rose tint dye a curved, transparent, glass or polymer member adapted to filter up to twenty-five percent of light substantially between 380 nanometers and 700 nanometers;
coating with a rose tint dye the curved, transparent, glass or polymer member adapted to filter up to thirty-five percent of light substantially between 380 nanometers and 500 nanometers;
coating with an optically filtering anti-glare and blue light the curved, transparent, glass or polymer member adapted to filter up to thirty-five percent of light substantially between 380 nanometers and 500 nanometers;
optically filtering with the rose tint dye the curved, transparent, glass or polymer member up to twenty-five percent of light substantially between 380 nanometers and 700 nanometers;
optically filtering with the rose tint dye the curved, transparent, glass or polymer member up to fifty percent of light substantially between 380 nanometers and 500 nanometers; and
optically filtering with the anti-glare and blue light coating disposed on the curved, transparent, glass or polymer member up to thirty-five percent of light substantially between 380 nanometers and 500 nanometers.

14. The method for filtering light to reduce photophobia of claim 13, the method including coating with the rose tint the curved, transparent, glass or polymer member to filter up to twenty percent of light between 380 nanometers and 470 nanometers and up to five percent of light between 470 nanometers and 700 nanometers, and filtering up to twenty percent of light between 380 nanometers and 470 nanometers and up to five percent of light between 470 nanometers and 700 nanometers.

15. The method for filtering light to reduce photophobia of claim 13, the method including coating with the rose tint the curved, transparent, glass or polymer member to filter up to fifteen percent of light substantially between 380 nanometers and 500 nanometers and filtering up to fifteen percent of light substantially between 380 nanometers and 500 nanometers.

16. The method for filtering light to reduce photophobia of claim 13, the method including coating with the optically filtering anti-glare and blue light the curved, transparent, glass or polymer member to filter up to fifteen percent of light substantially between 380 nanometers and 500 nanometers and filtering up to fifteen percent of light substantially between 380 nanometers and 500 nanometers.

17. The method for filtering light to reduce photophobia of claim 13, the method including coating with the rose tint optically filtering dye as a gradient on the curved, transparent, glass or polymer member adapted to filter up to thirty percent of light substantially between 380 nanometers and 470 nanometers at an upper portion of the curved, transparent, glass or polymer member, and coating a lower portion of the curved, transparent, glass or polymer member with the rose tint optically filtering dye to filter a lesser percentage of light down to five percent substantially between 380 nanometers and 470 nanometers and filtering light therethrough.

18. The method for filtering light to reduce photophobia of claim 13, the method including coating as a gradient with the optically filtering anti-glare and blue light coating the curved, transparent, glass or polymer member to filter up to thirty percent of light substantially between 380 nanometers and 470 nanometers at an upper portion of the curved, transparent, glass or polymer member, and coating a lower portion of the curved, transparent, glass or polymer member with the optically filtering anti-glare and blue light coating to a lesser percentage of light down to five percent substantially between 380 nanometers and 470 nanometers and filtering light therethrough.

19. The method for filtering light to reduce photophobia of claim 13, the method including first crafting a substantially rectangular curved, transparent, glass or polymer member as a prescription lens.

20. The method for filtering light to reduce photophobia of claim 13, the method including first crafting a substantially rectangular curved, transparent, glass or polymer member as a prescription lens.
